(19) United States
(12) Patent Application Publication
(10) Pub. No.: US 2010/0261386 A1
(43) Pub. Date: Oct. 14, 2010

(54) POWER LINE CARRIER NETWORK COMBINED WITH POWER SUPPLY

(75) Inventors: William R. Blum, Huntington Station, NY (US); Dean Mason, Plainview, NY (US)

Correspondence Address: HONEYWELL/HUSCH;Patent Services, 101 Columbia Road, P.O.Box 2245, Morrlstown, NJ, 07962, US

(73) Assignee: Honeywell International Inc., Morristown, NJ (US)

(21) Appl. No.: 12/421,779

(22) Filed: Apr. 10, 2009

(51) Int. Cl. H01R 13/66; H01R 33/00

(52) U.S. Cl. 439/620.21; 439/638

(57) ABSTRACT

An adapter is provided for connecting to an electrical wall outlet. The adapter includes a housing, a power conductor extending from the housing and that couples to a power side of the electrical wall outlet, a neutral conductor extending from the housing that couples to a neutral side of the electrical wall outlet, a receptacle disposed in the housing and indirectly coupled to the power and neutral conductors that receives a low voltage plug and that couples a low voltage data signal between the low voltage plug and wall outlet through the power and neutral conductors.

### FIELD OF THE INVENTION

The field of the invention relates to computers and, more particularly, to methods of interconnecting computers.

### BACKGROUND OF THE INVENTION

There is a need to interconnect computers for any of a number of different reasons. For example, files may need to be shared between computers. Alternatively, messages may be exchanged between users.

A number of different systems exist for interconnecting computers within a computer system. Hardwired routers may be used to interconnect a number of computers within a local area network (LAN) or wide area network (LAN). The Internet may provide another method of interconnecting computers.

While such techniques are reliable, they are often inconvenient or overly expensive for home use. Routers may be used to set up a LAN, but routers require wires to interconnect each computer to the router.

One alternative is the use of wireless bridges operating under the IEEE 802.11 standard. While the use of IEEE 802.11 bridges is effective, the wireless transmission of data can be intercepted by nearby computers operating under the same standard resulting in the loss of confidentiality.

In an effort to reduce to possibility of compromising confidentiality, the power levels of 802.11 devices is often quite low. However, the reduction of power levels used for the radio frequency transmission and reception of data also sometimes makes reliable communication difficult especially where the building in which the system is used is constructed of metal. Accordingly, a need exists for better methods of interconnecting computers in small networks that do not need additional wiring or that relies upon radio frequency signals transmitted directly between computers.

### BRIEF DESCRIPTION OF THE DRAWINGS

FIG. 1 is a block diagram showing a power line adapter in a context of use under an illustrated embodiment of the invention; and

FIG. 2 is a block diagram of the power line adapter of FIG. 1.

### DETAILED DESCRIPTION OF AN ILLUSTRATED EMBODIMENT

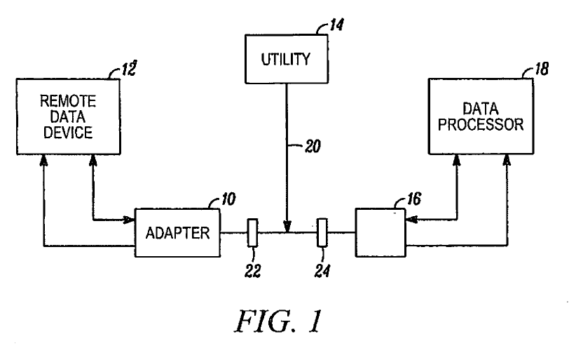

FIG. 1 is a block diagram showing a power line adapter 10 shown in a context of use generally in accordance with an illustrated embodiment of the invention. Under the illustrated embodiment, the power line adapter 10 is used to adapt a remote data device 12 for transmission of a data signal through a set of power lines 20 to a data processing device 18. The remote data device 12 may be any of a number of electronic data collection/use devices (e.g., an Internet Protocol (IP) camera, a home entertainment system, security sensors, heating/cooling control devices, etc.) used within the home.

Many new network appliances or remote data devices 12 are difficult to install and connect to an associated data processor 18 due to the need for either wiring the devices 12 to a home router connected to the data processor 18 or setting up a wireless connection between the device 12 and processor 18 using an IEEE 802.11 bridge. It has been proposed that dedicated data transmission wiring or 802.11 bridges could be eliminated by using the electrical wiring 20 within the home for exchanging data between the processor 18 and device 12 using a concept called “Home Plug.” Under the “Home Plug” concept an adapter is provided that plugs into an electrical wall outlet. The adapter provides isolation between the 110 volt alternating current (AC) power of the wall outlet and the low voltage data conductors of the device 12 while coupling a data signal between the device 12 and wiring 20. The difficulty with this concept is that the installation requires a fall duplex wall outlet for use. That is, one outlet is used for the adapter and the other outlet is used to power the device 12. The result is that the entire duplex outlet is devoted to the device 12.

Under the embodiment illustrated in FIG. 1, the adapter 10 functions to couple power to the device 12 from existing wiring 20 within the home through a single electrical outlet 22 from the utility 14. The adapter 10 also functions to couple a low voltage data signal between the device 12 and a data processing device 18 through the adapter 10, the outlet 22, the wiring 20, a second outlet 24 and a second adapter 16.

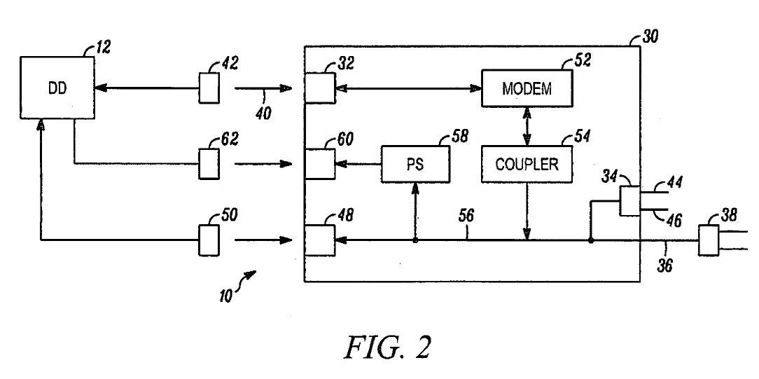

FIG. 2 is a block diagram of the adapter 10. As shown, the adapter 10 may include an integral housing 30 with at least one low voltage data receptacle (connector) 32 extending through the housing 30. The receptacle 32 is adapted to receive a low voltage data plug 42 from the data device 12 that externally plugs 40 into the adapter 10.

The housing 30 of adapter 10 may also externally support a 110 VAC male plug 34 either extending through the housing 30 or mounted on an external surface of the housing 30. Extending from the plug 34 is a first, power electrical conductor (or prong) 44 and a second, neutral electrical connector (or prong) 46. The plug 34 may also have a grounding prong (not shown) where required. The plug 34 is adapted to engage and electrically connect to the wall outlet 22 on a first end outside the housing 30 and a set of power and neutral conductors 56 inside the housing 30.

As an alternative to the plug 34, the housing 30 may have a two (or three) conductor electrical cord 36 extending from the housing 30. Located on a distal end of the cord 36 is an electrical plug 38. As before, the plug 38 has a power prong 44 and a neutral prong 46 and is adapted to engage the wall outlet 22.

The housing 30 may also support a female receptacle (or socket) 48. The female receptacle 48 receives a male plug 50 from the device 12. Male plugs 38 and 50 may be substantially the same.

Located within the housing 30 may be a modem 52. The modem 52 is indirectly coupled or connected with the electrical conductors 56 through a coupler 54. The coupling is indirect because the coupler 54 electrically isolates a first side of the modem 52 from the 110 volt AC power on the conductors 56 while electrically coupling a low voltage data signal between the conductors 56 and modem 52.

The indirect coupling provided by the coupler 54 may be either capacitive, inductive or optical. If the coupler 54 capacitively couples the modem 52 with the conductors, then the coupler 54 would include one or more capacitors that couple first and second low voltage conductors of the modem 52 with the respective conductors 56. If the coupler 54 inductively couples the modem, then a high frequency transformer is coupled between the modem 52 and conductors 56. Similarly, if the coupler 54 optically couples the modem, then a pair of electro-optic couplers are connected (in opposing directions for 2-way communication) between the modem 52 and 110 volt conductors 56.

The modem 52 may operate under any appropriate packet format (e.g., TCP/IP, Ethernet, HomePlug 1.0, HomePlug AV, etc.). The modem 52 may operate at a rate of 200 million bits per second (MBPS) and may transceive a data signal in both directions.

The housing of the adapter 10 may also contain an AC/DC power supply 58 that converts from 110 volts AC from the power lines 56 to one or more direct current (DC) voltages. The DC voltage(s) may be provided to one or more universal electrical receptacles (connectors) 60.

It should be noted that the remote data device 12 may be equipped to receive 110 volts AC through a first plug 50 or low voltage DC power through a second connector 62.

The power line adapter 10 offers a number of advantages over conventional devices. For example, as noted above, the adapter 10 only occupies one electrical receptacle of a duplex outlet. On the other hand, where a cord 36 and plug 38 are provided, then the adapter 10 can be located near the outlet or in any location set apart from the outlet 22.

A specific embodiment of a power line adapter has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. An adapter for connecting to an electrical wall outlet comprising:
a housing;
a power conductor extending from the housing and that couples to a power side of the electrical wall outlet;
a neutral conductor extending from the housing that couples to a neutral side of the electrical wall outlet;
a receptacle disposed in the housing and indirectly coupled to the power and neutral conductors that receives a low voltage plug and that couples a low voltage data signal between the low voltage plug and wall outlet through the power and neutral conductors.

2. The adapter of claim 1 wherein the first and second conductors further comprise prongs extending directly from the housing for insertion into the wall outlet.

3. The adapter of claim 1 wherein the receptacle further comprises first and second low voltage conductors that connect to respective first and second conductors within the low voltage plug.

4. The adapter of claim 3 wherein the indirect connection further comprises a capacitor coupling the first and second low voltage conductors of the receptacle to the power and neutral conductors.

5. The adapter of claim 3 wherein the indirect connection further comprising an inductor coupling the first and second low voltage conductors of the receptacle to the power and neutral conductors.

6. The adapter of claim 1 wherein the power and neutral conductors further comprising a power cord and plug extending from the housing that engages the household outlet.

7. The adapter of claim 1 further comprising a transformer disposed within the housing.

8. The adapter of claim 1 wherein the receptacle further comprising an Ethernet receptacle.

9. The adapter of claim 1 further comprising a modem disposed within the housing between the receptacle and power and neutral conductors.

10. An adapter for connecting to an electrical wall outlet comprising:
a housing;
a power prong extending from the housing and that couples to a power side of the electrical wall outlet;
a neutral prong extending from the housing that couples to a neutral side of the electrical wall outlet;
a data receptacle disposed in the housing and indirectly coupled to the first and second prongs that receives a low voltage plug and that couples a low voltage data signal between the low voltage plug and household outlet through the power and neutral prongs

11. The adapter of claim 10 wherein the indirect connection further comprises a capacitor coupling the first and second low voltage conductors of the receptacle to the power and neutral conductors.

12. The adapter of claim 10 wherein the indirect connection further an inductor coupling the first and second low voltage conductors of the receptacle to the power and neutral conductors.

13. The adapter as in claim 10 wherein the receptacle further comprising an Ethernet receptacle.

14. The adapter as in claim 10 further comprising a power receptacle disposed in the housing that supplies power to external devices.

15. An adapter for connecting to a wall outlet comprising:
a housing;
a power and neutral conductor extending on a proximal end from the housing;
a plug on a distal end of the power and neutral conductors that couples to the wall outlet;
a data receptacle disposed in the housing with first and second conductors inductively or capacitively coupled to the respective power and neutral conductors where the data receptacle receives a low voltage data plug and where the receptacle couples a low voltage data signal between the low voltage data plug and wall outlet through the power and neutral conductors.

16. The adapter as in claim 15 further comprising a power receptacle disposed in the housing that receives a power plug from another device.

17. The adapter as in claim 15 further comprising a direct current power supply disposed within the housing.

18. The adapter as in claim 17 further comprising a low voltage power receptacle disposed in the housing for supplying low voltage power to external devices.

19. The adapter as in claim 15 further comprising a modem within the housing that couples the data signal to the power and neutral conductors.

20. The adapter as in claim 15 wherein the data receptacle further comprising an Ethernet receptacle.
